(19) United States
(12) Patent Application Publication
(10) Pub. No.: US 2007/0073832 A1
(43) Pub. Date: Mar. 29, 2007

(54) Method and system of storing and accessing meta-data in a network adapter

(76) Inventors: Bryce A. Curtis, Round Rock, TX (US); Vincent J. Meriwether, Round Rock, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/236,452

(22) Filed: Sep. 27, 2005

(51) Int. Cl. G06F 15/16

(52) U.S. Cl. 709/217

(57) ABSTRACT

A method and system for accessing and retrieving information stored on a network adapter. In an exemplary embodiment, the method includes sending a request by a first system to a network adapter disposed within a second system. The first system includes network capabilities. Further, the first system and second system are communicatively coupled via a network. The request is processed by the network adapter disposed with the second system and network adapter memory is accessed to retrieve the information in accordance with the request. Finally, a response in accordance with the request is sent by the network adapter to the first system.

### FIELD OF THE INVENTION

The present invention generally relates to the field of operating and network systems, and more particularly to a method and a system for accessing and storing meta-data in a network adapter.

### BACKGROUND OF THE INVENTION

As reliance upon computers for communicating in both personal and business settings continues to increase, more efficient and less cumbersome interaction amongst multiple computers is desirable. Presently, a network adapter may be employed to allow high speed communications to occur between multiple computers all part of a common network. Network adapters are used by computers to send and receive packets of information.

Although network adapters have greatly increased the speed and efficiency in which computers within a given network may communicate with each other, currently available network adapters are only able to store limited information. For example, information currently stored on network cards includes the Media Access Control (MAC) address which is a hardware address that uniquely identifies each node of a network. Further, for wireless cards, the encryption keys for the Wireless Access Point (WAP) are stored on such cards. In addition, there is no ability to access such information without the use of network drivers or an operating system (OS).

The inability of a network adapter to access and store general information about a system while the system is powered off or in low power mode (e.g., standby mode) imposes limitations on the system. For instance, there are several pieces of information about a system on a network that would be useful to know about that system, even if the system is not powered “on” or is running another OS at the time. If a user were able to query such information over the network, then system scans for such tasks as inventory, OS type, and hardware configuration may be easily accomplished. Further, by enabling network cards to respond even when the system is turned off or in standby mode, a network scan of all systems attached to the network may be performed, thereby allowing an accurate representation of the network to be obtained.

Therefore, it would be desirable to provide a method and system which would allow a network adapter to store information about a system when the system containing the adapter is in a power off or low power mode.

### SUMMARY OF THE INVENTION

In a first aspect of the invention, a method for accessing and retrieving information stored on a network adapter is provided. In the present aspect, the method includes sending a request by a first system to a network adapter disposed within a second system. The first system and second system are communicatively coupled via a network. The request is processed by the network adapter disposed with the second system and network adapter memory is accessed to retrieve the information in accordance with the request. Finally, a response in accordance with the request is sent by the network adapter to the first system.

In a further aspect of the present invention, a computer-readable medium having computer-executable instructions for performing a method of accessing and retrieving information stored on a network adapter is disclosed. In an aspect, the method includes sending a request by a first system to a network adapter disposed within a second system, the first system and second system being communicatively coupled via a network. Further, the request is then processed by a network adapter disposed with the second system and memory of the network adapter is accessed in order to retrieve the information in accordance with the request. Next, a response in accordance with the request is sent by the network adapter disposed within the second system to the first system allowing the two systems to share information.

In an additional aspect of the present invention, a system capable of requesting and accessing information stored on a network adapter is provided. In accordance with an exemplary aspect, the system includes a first computer system. Further, a second computer system is communicatively coupled to the first system via a network for allowing the first computer system and second computer system to share information. In addition, a network adapter is disposed within the second computer system for storing information. Such network adapter includes memory. The present system is designed to allow the first computer system to request and access information from the network adapter disposed within the second computer system without the second computer system leaving a low-power state such as “standby” or “power off” mode.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method of a source system requesting and accessing data in a destination system in accordance with an exemplary embodiment of the present invention, wherein information is stored and accessed on a network adapter;

FIG. 2 is an exemplary definition for a network adapter using IEEE 802.3 standard with a packet in accordance with an exemplary embodiment of the present invention;

FIG. 3 is exemplary code for requesting information by a source system to a destination system in accordance with an exemplary embodiment of the present invention; and

FIG. 4 is a block diagram illustrating a system capable of requesting and accessing information from a network adapter in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

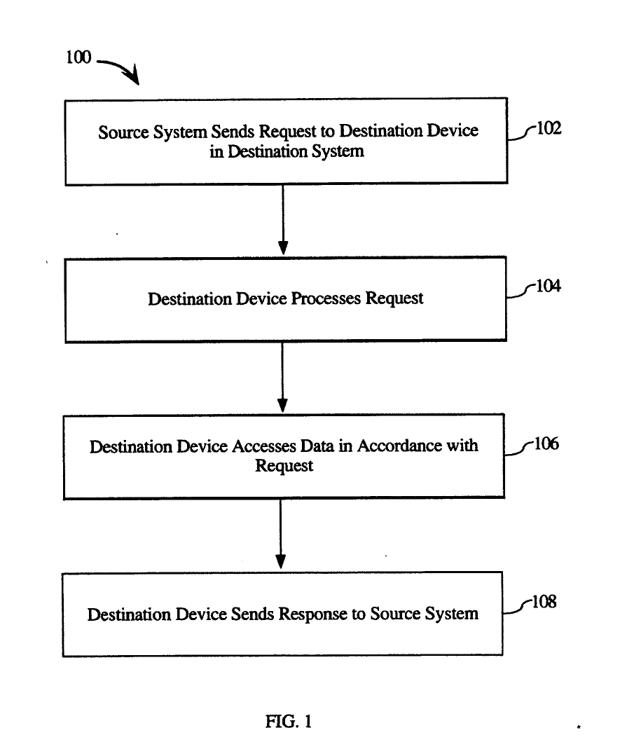

Referring to FIG. 1, a method 100 of accessing and retrieving information stored on a network adapter is disclosed. In an embodiment, the method 100 of accessing and retrieving information stored on a network adapter includes sending a request by a first computer system or source system to a destination device such as a network adapter disposed within a destination system 102. In such embodiment, the first or source system includes a network card. Further, the first or source system is communicatively coupled to a second or destination systems via a network. Although it is contemplated that the source system may be a computer system other devices with network capabilities such as a network, router may also serve as the source system. Next, the request is processed by network adapter disposed within the second system 104. Memory of the network adapter is then accessed to retrieve information in accordance with the request 106 and a response in accordance with the request is sent by the network adapter to the first system 108.

In an exemplary embodiment, the network adapter includes non-volatile readable and writable memory allowing information about the OS and configuration settings to be stored on the network adapter and accessed directly through the network without the use of network drivers or an OS. Further, this memory may be written by any software including a network adapter device driver or other hardware devices.

It is contemplated that the information stored in the memory may be textual or binary. For instance, data which describes other data, often referred to as meta-data, may be stored in the network adapter memory. Examples of meta data include data element descriptions, data type descriptions, attribute/property descriptions, range/domain descriptions and process/method descriptions. For example, the information stored in the network adapter memory is saved in the format of property name/value pairs (property n, value n) such as (property1, value1). In accordance with the prior example, to store OSes installed on the system, the pairs (“os”, “redhat linux”), (“os”, “windows xp professional”) may be used. Thus, by querying the network adapter over the network, the installed OSes may be detected and information about a particular configuration setting under an OS may be stored by the pair (e.g., “redhat linux/ip”, “192.168.1.1.”). In addition, it is contemplated that additional information may be included with the property such as a password which is required to access the property. For example, recognition of a password included with the request by the second system prior to accessing network adapter memory allows information on the second system to be protected from unknown systems on the network.

In further exemplary embodiments of the method 100, processing of the request 104, accessing network adapter memory 106, and sending a response 108 may be performed while the second system is in a low-power state such as that associated with power off or standby mode. For example, when a particular request or command directed to the network adapter disposed within the second system or destination system is received, the network adapter performs a memory lookup and returns the requested information to the source system without the network adapter or system leaving the low-power state. In an embodiment, a network adapter employs the Wake-on-LAN disposed within the adapter to allow the adapter to wake a machine when a special MAGIC PACKET™ frame is received on the network

As mentioned previously, there are several pieces of information about a system on a network that would be useful to know about that system, even if the system is not powered “on” or is running another operating system at the time. Such information may include the OS, configuration settings, and hardware information. For example, a user may query such information over the network, then system scans for such tasks as inventory, OS type, and hardware configuration may be easily accomplished. In addition, by enabling network adapters to respond even when the system is turned off or in standby mode, a network scan of all systems attached to the network may be performed, thereby allowing an accurate representation of the network to be obtained.

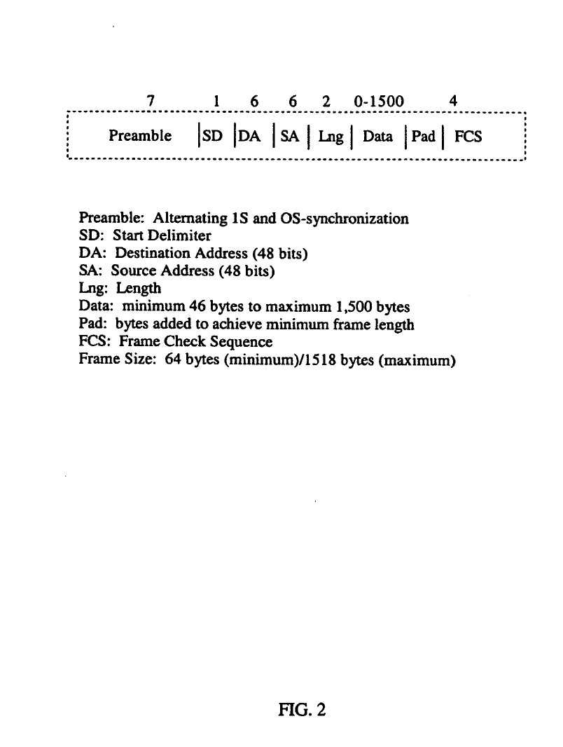

Referring to FIG. 2, an exemplary frame for an Ethernet network adapter with IEEE 802.3 standards is provided. In the present embodiment, information is transmitted within the network via small segments or packets. A packet is a basic data unit which may include a header and data body. The header includes essential data such as source and destination IP address and protocol type. The use of packets provides for efficient transmission of information, thus if an error is detected in any packet or a packet is lost, only the particular packet which includes an error or is missing needs to be resent, not the entire transmission.

Ethernet network adapters such as those which may be utilized in the present invention use the IEEE 802.2xx standards (e.g., 802.2 through 802.11x standards) with each packet (RFC 894 and 1042). FIG. 2 provides an example of a frame format employed by an Ethernet network adapter with IEEE 802.3 standards. In the present example, the frame header includes the preamble, the start delimiter (SD), the destination IP address (DA), the source IP address (SA), and the packet length (Lng). The preamble alternates between 1s and Os to synchronize a first system or source system with the destination system or second system in which the Ethernet network adapter is disposed. SD signals the start of a valid frame. In the present example, the DA and SA each contain forty-eight (48) bits. Further, Lng indicates the number of bytes in the data. In the example, data may be a minimum of forty-six (46) bytes to a maximum of fifteen hundred (1500) bytes. Pad denotes the number of bytes added to achieve a minimum frame length allowing for reliable collision detection. In addition, FCS (Frame Check Sequence) includes an algorithm for detection of errors in the frame. Furthermore, frame size in the present example may be between sixty-four (64) bytes minimum and fifteen hundred and eighteen (1518) bytes maximum.

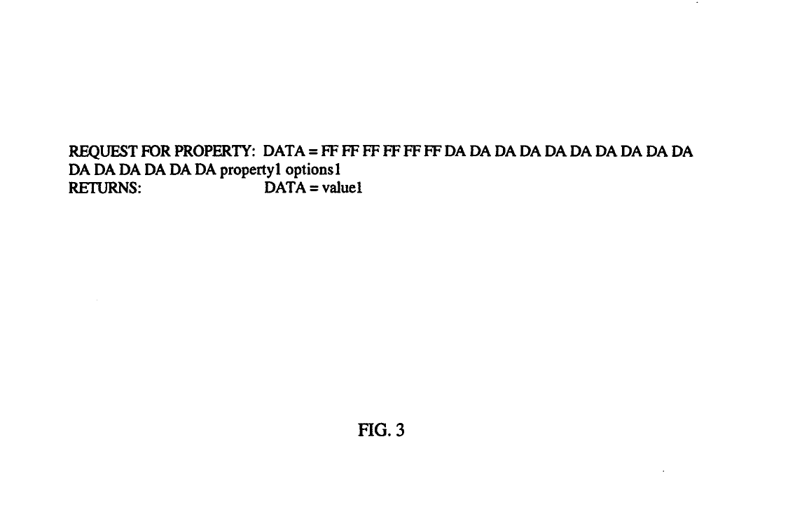

Referring to FIG. 3, an exemplary packet in accordance with the present invention is provided. In the embodiment, the network adapter employs the Wake-On-LAN technology designed by IBM for remotely powering on and configuring a computer through a network management application. The Wake-On-Lan function is included within the network adapters so that the adapter may wake a machine by utilizing a MAGIC PACKET™. The MAGIC PACKET™ is a protocol devised by Advance Micro Devices to trigger the remote wake-up of a computer via a network connection. Wake-On-LAN's remote wake-up function relies on the MAGIC PACKET™ being transmitted via the network connection to initiate the system wake-up sequence.

The exemplary MAGIC PACKET™ includes a broadcast (e.g., six (6) bytes of FF) allowing all computers within the network to be contacted and sixteen (16) duplications of the DA. The six (6) bytes of FF and sixteen (16) duplications of the DA may be located anywhere within the data. With such configuration, all computers within the network receive the broadcast message and compare their host name with that in the data field. However, only the computer including the specified DA will be accessed and ultimately, respond. It is contemplated that while an exemplary embodiment may use a MAGIC PACKET™ to initiate a system wake-up sequence other unique packets may be employed to perform such sequence.

In an embodiment, the six (6) bytes of FF and sixteen (16) duplications of the DA may be followed by a requested property name, options, or the like. As illustrated in FIG. 3, the request for property includes the six (6) bytes of FF, sixteen (16) duplications of the DA, property1 and options1. Proprerty1 indicates the property which is being requested and options1 indicates additional information that is required in order to access the property (e.g., a password or user id). As previously described, use of a password protects the destination system or second system from intrusions by unknown systems on the network. Further, as illustrated by FIG. 3, the destination system may respond to the request for property with a value response denoted as value1.

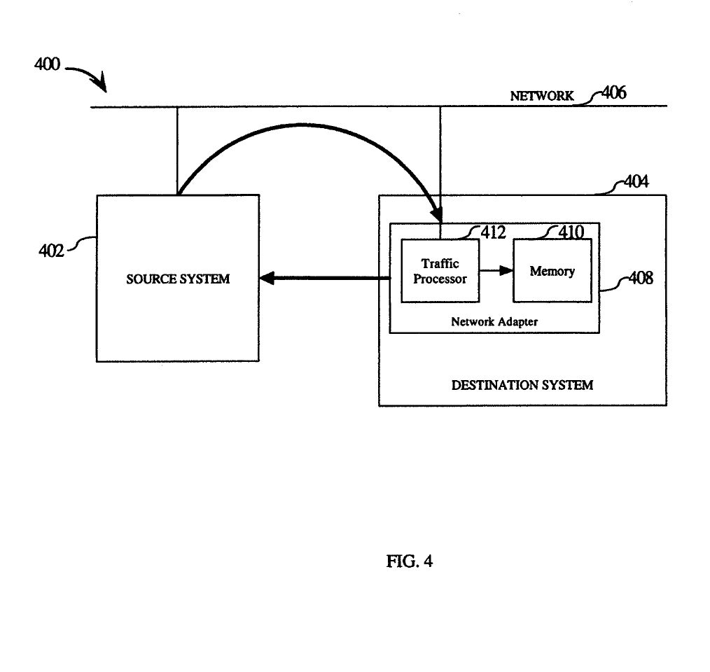

Referring to FIG. 4, a system 400 capable of requesting and accessing information stored on a network adapter is provided. In an exemplary embodiment, the system 400 includes a first computer system or a source system 402. The source system 402 is communicatively coupled to a second system or destination system 404 for allowing the first computer system 402 and the second system 404 to share information. For example, the first system 402 is communicatively coupled to the second system 404 via a network 406 such as the Internet.

In the present embodiment, the destination system or second system 404 includes a network adapter 408 for storing information. It is contemplated that the information may include the OS and configuration settings. As illustrated in FIG. 4, the network adapter 408 includes memory 410 and a traffic processor 412. In an embodiment, the memory 410 is non-volatile readable and writable memory. Further, such memory 410 may be written by various types of software including a network adapter device driver.

In an exemplary scenario, as depicted by FIG. 4, the first system or source system 402 sends a request to the network adapter 408 located within the destination system 404. The network adapter 408 processes the information/request via the traffic processor 412 and performs a memory lookup to retrieve the information in accordance with the request. The network adapter 408 within the destination system 404 then sends a response to the first system or source system 402. As mentioned previously, it is contemplated that such processing, memory look-up and response to request may all be performed without the network adapter leaving the low-power state associated with power off or standby.

Although the present method and system involves two systems, it is contemplated that the number of systems may vary depending upon the size and complexity of the network. It is also contemplated that the network may be established within a single building such as a home network linking multiple systems disposed within the dwelling or involve systems located at numerous locations. In addition, the Internet or intranet may be employed to establish the network.

It is to be noted that the foregoing described embodiments according to the present invention may be conveniently implemented using conventional general purpose digital computers or other programmable network hardware devices programmed according to the teachings of the present specification, as may be apparent to those skilled in the computer art. Appropriate software coding may readily be prepared by skilled programmers based on the teachings of the present disclosure, as may be apparent to those skilled in the software art.

It is to be understood that the present invention may be conveniently implemented by use of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of accessing and retrieving information stored on a network adapter, comprising steps of:
sending a request by a first system to a network adapter disposed within a second system, the first system and second system being communicatively coupled via a network, the first system including network capabilities;
processing the request by the network adapter disposed with the second system;
accessing a memory of the network adapter in accordance with the request; and
sending a response in accordance with the request by the network adapter to the first system.

2. The method of accessing and retrieving information stored on a network adapter as claimed in claim 1, wherein at least one of the steps of processing the request, the step of accessing the memory of the network adapter, or the step of sending a response is performed while the second system is in a low-power state.

3. The method of accessing and retrieving information stored on a network adapter as claimed in claim 1, further comprising a step of recognizing a user specific identification code included with the request by the second system prior to accessing the memory of the network adapter for allowing information on the second system to be restricted from unknown systems on the network.

4. The method of accessing and retrieving information stored on a network adapter as claimed in claim 1, wherein the memory of the network adapter includes at least one of readable or writable memory.

5. The method of accessing and retrieving information stored on a network adapter as claimed in claim 1, wherein the memory of the network adapter includes at least one of binary files or textual files.

6. The method of accessing and retrieving information stored on a network adapter as claimed in claim 1, wherein the information stored in the memory of the network adapter includes meta-data.

7. The method of accessing and retrieving information stored on a network adapter as claimed in claim 1, wherein the request includes a broadcast, a destination address, a property name and value.

8. The method of accessing and retrieving information stored on a network adapter as claimed in claim 7, wherein the request further comprises an option, the option including a user specific identification code.

9. A computer-readable medium having computer-executable instructions for performing a method of accessing and retrieving information stored on a network adapter, the method comprising steps of:
sending a request by a first system to a network adapter disposed within a second system, the first system and second system being communicatively coupled via a network;
processing the request by network adapter disposed with the second system;
accessing a memory of the network adapter in accordance with the request; and
sending a response in accordance with the request by the network adapter to the first system.

10. The computer-readable medium as claimed in claim 9, wherein at least one of the steps of processing the request, accessing the memory of the network adapter, or sending a response are performed while the second system is in a low-power state.

11. The computer-readable medium as claimed in claim 9, wherein the request includes a user specific identification code.

12. The computer-readable medium as claimed in claim 9, wherein the method further comprises a step of recognizing a password included with the request by the second system prior to accessing the memory of the network adapter for allowing information on the second system to be restricted from unknown systems on the network.

13. The computer-readable medium as claimed in claim 9, wherein the memory of the network adapter includes at least one of readable or writable memory.

14. The computer-readable medium as claimed in claim 9, wherein the memory of the network adapter includes at least one of binary files or textual files.

15. The computer-readable medium as claimed in claim 9, wherein the information stored in the memory of the network adapter is saved in the format of name/value pairs.

16. A system capable of requesting and accessing information stored on a network adapter, comprising:
a source system;
a destination system communicatively coupled to the source system via a network for allowing the source system and destination system to share information;
a network adapter disposed within the destination system for storing information, the network adapter including a memory,
wherein the source system may request and access information from the network adapter disposed within the destination system when the destination system is in a low-power state.

17. The system as claimed in claim 16, wherein the request includes a user specific identification code.

18. The system as claimed in claim 16, wherein the network adapter memory includes at least one of readable or writable memory.

19. The system as claimed in claim 16, wherein the network adapter memory includes at least one of binary files or textual files.

20. The system as claimed in claim 16, wherein the information stored in the network adapter memory is saved in the format of name/value pairs.
